(19) United States
(12) Patent Application Publication
(10) Pub. No.: US 2002/0178114 A1
(43) Pub. Date: Nov. 28, 2002

(54) User-centric merchandising and financial services

(75) Inventor: Tommy C. Poon, Murray Hill, NJ (US)

Correspondence Address: Patent Department, Mitsubishi Electric Research Laboratories, Inc., 201 Broadway, Cambridge, MA, 02139, US

(73) Assignee: Mitsubishi Electric Research Laboratories, Inc.

(21) Appl. No.: 09/866,120

(22) Filed: May 25, 2001

(51) Int. Cl. G06F 17/60

(52) U.S. Cl. 705/39

(57) ABSTRACT

A method performs a commercial transaction via a network. A commercial transaction is specified by a particular user in a personal access module connected to the network. The commercial transaction is received in a personal access link configured to operate according to a profile associated with the user. The commercial transaction is forwarded to a financial institution system depending on the profile of the user, and the financial system forwards the commercial transaction to a selected merchant system depending on the profile associated with the user and the commercial transaction.

### FIELD OF THE INVENTION

This invention relates generally to systems and methods for providing commercial transactions, and more particularly to perform commercial transactions using the Internet.

### BACKGROUND OF THE INVENTION

As the use of the Internet has been become more pervasive, so has Internet commerce, or “e-commerce.” All modem businesses nowadays provide some means for interacting with users of the Internet. The standard model for providing commercial transactions via the Internet has become well established, as shown in FIG. 1.

Typically, a user 101 with a client (user) computer system 110, for example, a home PC, selects a server (merchant system) 120 of some selected goods or service provider (merchant) 102. The selection can be made via browser interface software, e.g., Netscape Navigator™ executing on the user system 110. The user may select the merchant using search tools, such as Alta Vista™, or a portal 140 such as Yahoo™.

In either case, the user selects products or services to be purchased and provides 111 the merchant with a credit card number. Upon certification of a valid form of payment, the merchant delivers 112 the purchased items to the user. As a result of the transaction, the merchant forwards 122 the transaction to an appropriate financial institution 130, e.g. a bank 103. The financial institution advances 121 payment to the merchant, usually minus some commission or service charge. On a monthly basis, the financial institution bills 131 the user 110, and the user remits 132 payment.

In this model, the merchant's transactions with the financial institution is transparent to the user, other than the fact that the user is required to supply a credit card number to the merchant, or portal. The user has no choice or control over the arrangements 121-122 between the merchant and the bank. Similarly, the transactions between the financial institution and the user are transparent to the merchant. In addition, there is very little of added-value, other than that the user can make purchases via the Internet, perhaps saving a trip to the store. Some merchants may also provide temporary preferences (prf) 125 based on past or current transactions. This is done quite often in the book or music industry, where the merchant may suggest other items to the user that match some preference selection criteria.

In the standard model, the merchant's offering of goods is severely limited to the genre of goods or services provided by the merchant, for example, books or music. A book seller would not suggest what type of car the user be interested in buying, the next time the user in the market for a new car. Similarly, it the user were to contact a bank's web site, all that would be offered would be banking type products and services. One would not buy a motorcycle through a bank's web site. The standard model is basically a “push” model 100, where the operators of the various Web pages use “pop-up” windows to entice the user to other like products and like services. Often, the user gets “locked” into merchant pages from which there is no escape.

In addition, there is no incentive for the merchant to require the user to use a particular type of credit card. In fact, most Internet purchases can be done with any type of credit card. In such a model, there is no incentive or means for the financial institution to differentiate itself, or to control how the user makes purchases. And, of course the user has no control how the transaction is processed after the merchant has been selected.

Therefore, there is a need for a business model that provides the user and the financial institution with added benefits.

### SUMMARY OF THE INVENTION

The invention provides a system and method for performing a commercial transaction via a network. A commercial transaction is specified by a particular user in a personal access module connected to the network. The commercial transaction is received in a personal access link configured to operate according to a profile associated with the user. The commercial transaction is forwarded to a financial institution system depending on the profile of the user, and the financial system forwards the commercial transaction to a selected merchant system depending on the profile associated with the user and the commercial transaction.

### BRIEF DESCRIPTION OF THE DRAWINGS

FIG. 1 is a block diagram of a prior art Internet based commercial transaction system; and

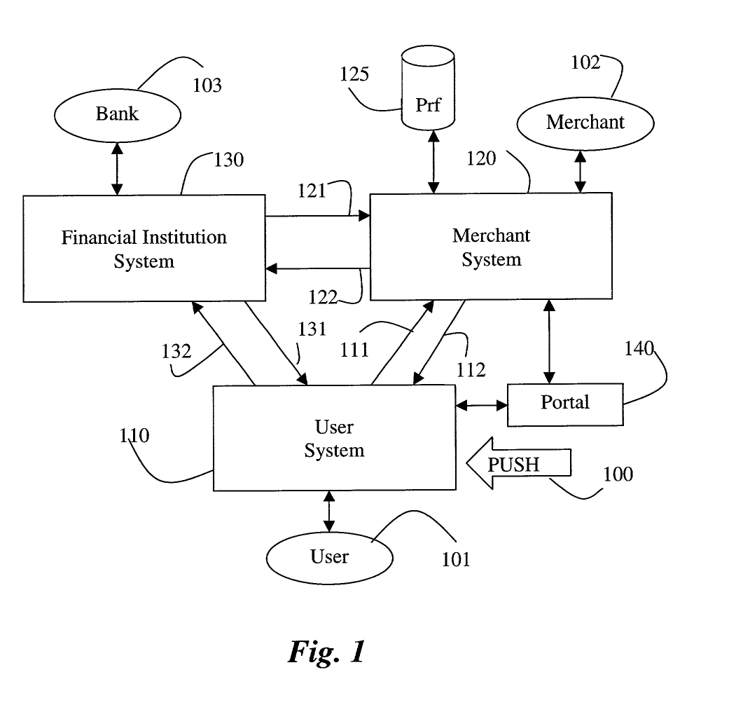

FIG. 2 is a block diagram of a system and method for performing commercial transactions according to the invention.

### DETAILED DESCRIPTION OF THE PREFERRED EMBODIMENT

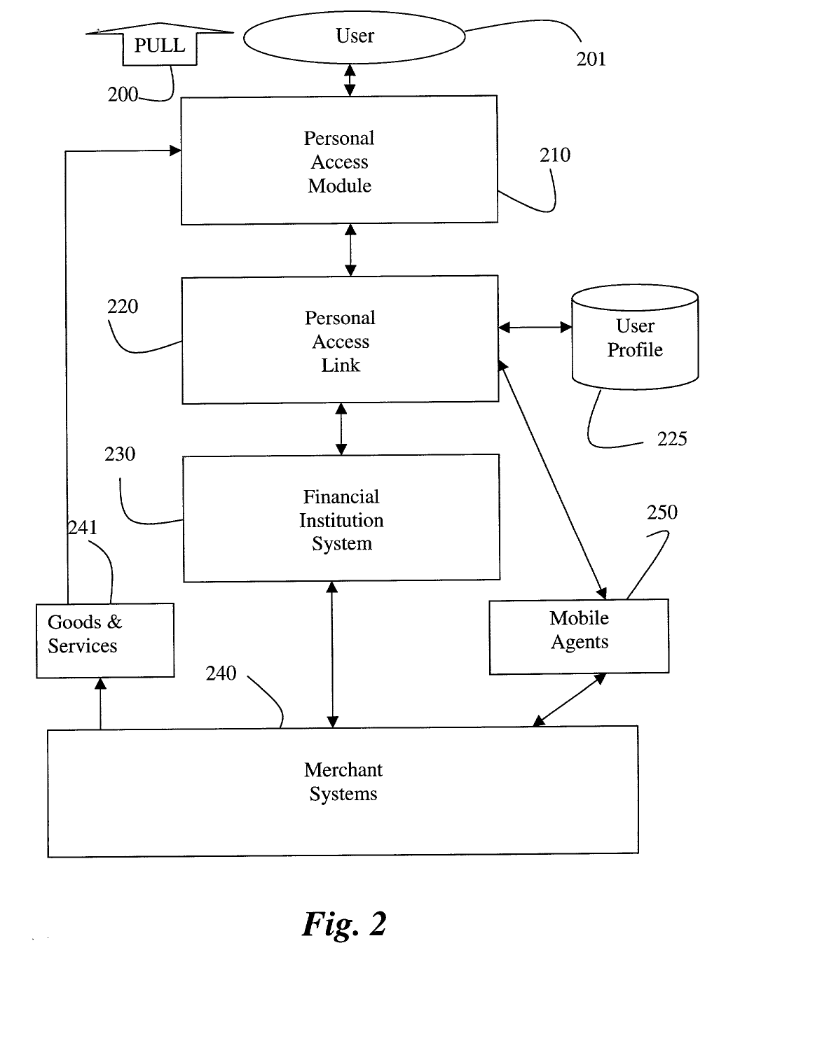

As shown in FIG. 2, the invention provides a system and method for performing commercial transactions that are user-centric. The model according to the invention, in contrast with the prior art is a “pull” model 200, where the user is in control, and not the merchant.. In the system according to the invention, the user interacts with a personal access module (PAM) 210. The PAM can be in the form of a PC coupled to the Internet by a wire link, or a mobile device, such as a personal digital assistant or a cellular telephone. The PAM can be configured to automatically select a specific personal access link 220, in the form of a web-site related to a specific financial institution 230. The financial institution has access to a large number of different merchant systems or servers 240 providing a variety of goods and services 241.

As a feature, the personal access link 220 maintains an associated user profile 225 for each of the users that access the system. The profiles 225 established here are quite distinct form the preference lists maintained by standard e-commerce systems. Here, the profile is “self-generating” and “self-improving” over the long-term. Thus, the goods and services that the user sees presented on the personal access link 210 are determined by the user 201 and not the merchant systems 240. Because the PAM 220 has direct or indirect access to a large number of merchants 240, the variety of goods and services provided is much larger that a prior art system. Second, the PAM can provides a consistent user interface for all of the merchants. Thus, the user is not bewildered by a different graphical presentation depending on the specific merchant who ultimately provides the goods and services 241. In fact, the user can customize a particular interface, and store the customization parameters as part of his or her profile 225.

Note, also that the relation of the user is directly with the personal access link 220 provided by the financial institution 230, and not the merchants 240 as in the prior art. This gives the financial institution 230 an incentive to acquire and maintain a base of loyal customers. This is not possible with the merchant-centric systems of the prior art. Also, the financial institution, in return for providing the personal access link, and access to the merchant systems 240 can get involved in profit sharing of the transactions performed by the users. This is in contrast with the standard model, where the financial institution's activities are strictly background “off-line” operations. Here, the financial institution is “in-line” with the transactions.

For example, as an incentive the financial institution can provide the user with a PAM (cell-phone) from a specific telephone provider. The PAM can then, by design, can identify the user, in conjunction with a personal identification code (PIN) for security purposes. Thus, the user is relieved of the burden of carrying a credit card. Also, the user can make purchases while operating in a highly mobile manner. The user's profile 225 is built by the use of “mobile intelligent agents,” see U.S. Pat. No. 6,233,601 “Itinerary based agent mobility including mobility of executable code” issued to Walsh on May 15, 2001. The mobile agent can perform an exhaustive search of the Internet to construct an ideal personal profile for a particular user.

This invention is described using specific terms and examples. It is to be understood that various other adaptations and modifications may be made within the spirit and scope of the invention. Therefore, it is the object of the appended claims to cover all such variations and modifications as come within the true spirit and scope of the invention.

I claim:

1. A method for performing a commercial transaction via a network;
specifying a commercial transaction for a particular user in a personal access module connected to the network;
receiving the commercial transaction in a personal access link configured to operate according to a profile associated with the user;
forwarding the commercial transaction to a financial institution system depending on the profile of the user; and
forwarding the commercial transaction from the financial institution system to a selected merchant system depending on the profile of the user and the commercial transaction.

2. The method of claim 1 wherein the user profile is generated and updated using a mobile agent.

3. The method of claim 1 wherein the personal access module identifies the user and a method of payment.

4. The method of claim 1 wherein the personal access link is a web site operated by the financial institution system.

5. The method of claim 1 wherein the financial institution system is coupled to a plurality of merchant systems.

6. A system for performing a commercial transaction via a network;
a personal access module connected to the network for specifying a commercial transaction for a particular;
a personal access link configured to operate according to a profile associated with the user and for receiving the commercial transaction;
a financial institution system for receiving the commercial transaction depending on the profile of the user; and
a selected merchant system for receiving commercial transaction from the financial institution system depending on the profile of the user and the commercial transaction.
